(19) United States
(12) Patent Application Publication
(10) Pub. No.: US 2013/0130743 A1
(43) Pub. Date: May 23, 2013

(54) Audio Jack Magnetic Card Reader

(71) Applicant: Sheng LIN, Shenzhen (CN)

(72) Inventor: Sheng LIN, Shenzhen (CN)

(21) Appl. No.: 13/680,099

(22) Filed: Nov. 18, 2012

(30) Foreign Application Priority Data
Nov. 18, 2011 (CN) 201110369613.9

(51) Int. Cl. H04M 1/02

(52) U.S. Cl. CPC H04M 1/0274
USPC 455/557

(57) ABSTRACT

The invention provides an audio jack magnetic card reader, comprising: an audio interface connecting a headphone jack of a mobile phone and comprising a first soundtrack terminal, a second soundtrack terminal and a microphone terminal; a data transmitting unit electrically connecting the microphone terminal so as to transmit the data to the mobile phone; a data receiving unit electrically connecting the second soundtrack terminal so, as to, receive the data from the mobile phone; an encryption module electrically connecting the data transmitting unit and the data receiving unit and stored with a key and a digital certificate; and a power-taken module of which the input terminal is electrically connected with the first soundtrack terminal and of which the output terminal provides power to the data transmitting unit the data receiving unit and the encryption module.

### FIELD OF THE INVENTION

The present invention relates to the card reader field, particularly to an audio jack magnetic card reader.

### BACKGROUND OF THE INVENTION

With the development of a smart phone, more and more users can carry out financial transactions through the mobile phone. Therefore, new requirements are proposed for the security of financial transactions based on a platform of the mobile phone. However, most of magnetic card readers in the prior art are matched with a computer to be used The prior art hence needs a portable magnetic card reader with good compatibility, which is used for different mobile phones.

### SUMMARY OF THE INVENTION

The invention aims to provide a magnetic card reader with good compatibility which is used for different mobile phones.

In order to solve the abovementioned technical problem, the invention provides a magnetic card reader, comprising: an, audio interface connecting with a headphone jack of a mobile phone and comprising a first soundtrack terminal, a second soundtrack terminal and a microphone terminal; a data transmitting unit electrically connecting the microphone terminal so as to transmit the data to the mobile phone; a data receiving unit electrically connecting the second soundtrack terminal so as to receive the data from the mobile phone; an encryption module electrically connecting the data transmitting unit and the data receiving unit and stored with a key and a digital certificate; a power-taken module of which the input terminal is electrically connected with the first soundtrack terminal and of which the output terminal provides power to the data transmitting unit, the data receiving unit and the encryption module, a card slot for swiping a card; and a control unit electrically connecting the data transmitting unit, the data receiving unit, the encryption module and the card slot.

Furthermore, the power-taken module receives a sine audio signal from the mobile phone through the first soundtrack terminal.

Furthermore, the power-taken module increases the voltage of the sine audio signal to be supply voltage through the way of phase congruency

Furthermore, the data receiving unit receives the signal from the mobile phone through the second soundtrack terminal and transforms the signal into data to be received based on the frequency of the signal.

Furthermore, the data transmitting unit transforms the data to be transmitted into the signal with different frequencies and transmits the signal to the mobile phone through the microphone terminal.

Furthermore, the key and the digital certificate are downloaded and obtained from the mobile phone via the data receiving unit.

Furthermore, a magnetic card is a magnetic stripe card.

Furthermore, the magnetic stripe card comprises a bank, card and a membership card.

Furthermore, the bank card comprises a credit card.

The magnetic card reader takes power through the headphone jack of the mobile phone and implements two-way communication between the headphone jack of the mobile phone and the magnetic card reader, thus facilitating the magnetic card reader to have relatively good compatibility, be adapted to the mobile phone in different models, and improve security of financial transactions of the platform of a mobile phone.

### BRIEF DESCRIPTION OF THE DRAWINGS

FIG. 1 is a state diagram when the invention is matched with a mobile phone and used.

FIG. 2 is a structural schematic diagram of the invention.

FIG. 3 is a schematic diagram of a power-taken circuit.

FIG. 4 is a schematic diagram of a data communication.

### DETAILED DESCRIPTION OF THE EMBODIMENTS

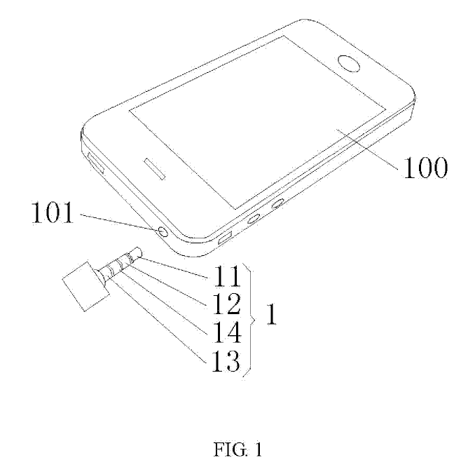

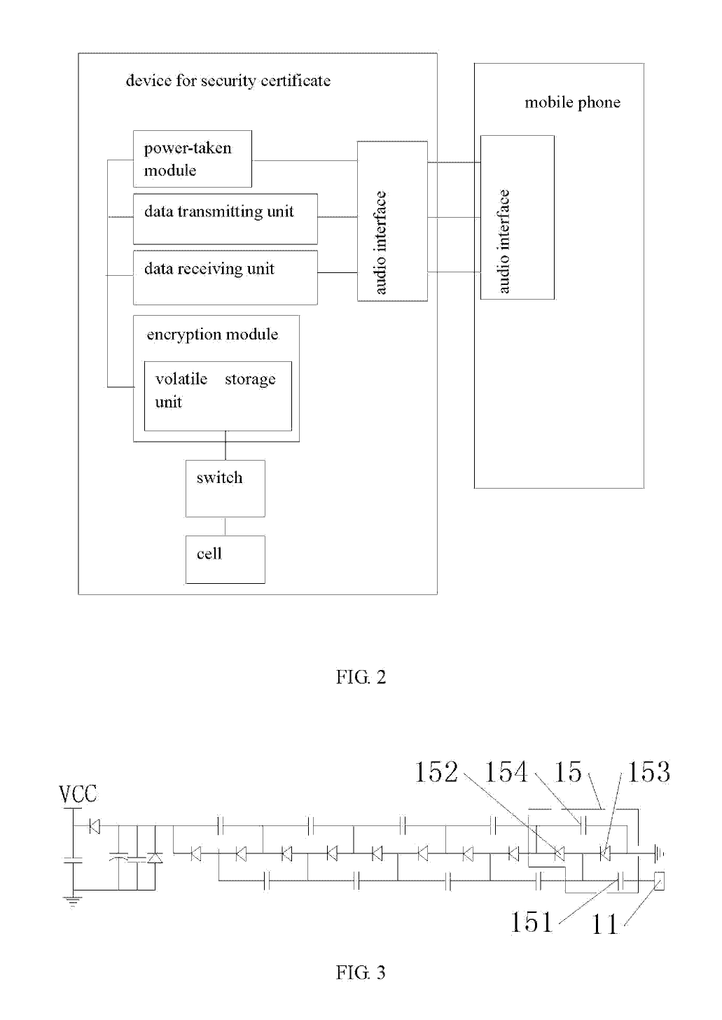

As shown in FIGS. 1-2, the audio jack magnetic card reader in the invention includes: an audio interface 1 connecting with a headphone jack 101 of a mobile phone 100 and comprising a first soundtrack terminal 11, a second soundtrack terminal 12, and a microphone terminal 13; a data transmitting unit electrically connecting the microphone terminal 13 so as to transmit the data to the mobile phone 100; a data receiving unit electrically connecting the second soundtrack terminal 12 so as to receive the data from the mobile phone 100; an encryption module electrically connecting the data transmitting unit and the data receiving unit and stored with a key and a digital certificate; a power-taken module of which the input terminal is electrically connected with the first soundtrack terminal 11 and of which the output terminal provides power to the data transmitting unit, the data receiving unit, and the encryption module; a card slot for swiping a card, and a control unit electrically connecting the data transmitting unit, the data receiving unit, the encryption module, and the card slot. Therefore, the invention can take power through the headphone jack of the mobile phone and also can read the information in a magnetic card through the card slot. The mobile phone can transmit the data which are needed to be transmitted to the magnetic card reader to the data receiving unit through the second soundtrack terminal. When the magnetic card reader is needed to transmit the data to the mobile phone, it can transmit them to the mobile phone through the microphone terminal via the headphone jack of the mobile phone. The two-way communication and power supply can be realized through the audio interface (particularly the headphone jack with the microphone terminal) between the magnetic card reader and the mobile phone, thus having good compatibility and being adapt for different mobile phones. Only through the connection between the invention and the mobile phone, the function that the mobile phone can swipe card can be realized, thus providing great convenience for the users. In addition, the invention is portable and thus can facilitate a mobile key to be a breakthrough in the application of financial transaction of the mobile phone, thus enhancing the security of the financial transaction, of the platform of the mobile phone. Preferably, the first soundtrack terminal is a left, soundtrack terminal, and the second soundtrack is a right soundtrack terminal; or the first soundtrack terminal is a right soundtrack terminal, and the second soundtrack is a left soundtrack terminal; Preferably, the audio interface also comprises a grounding terminal 14 electrically connected with the grounding terminal in the headphone jack of the mobile phone.

Preferably, the power-taken module receives a sine audio signal from the mobile phone 100 through the first soundtrack terminal 11. The power-taken module increases the voltage of the sine audio signal to be supply voltage through the way of phase congruency, so that it can supply power to each module in the magnetic card reader. Preferably, the frequency of the sine audio signal is 5 KHz-20 KHz.

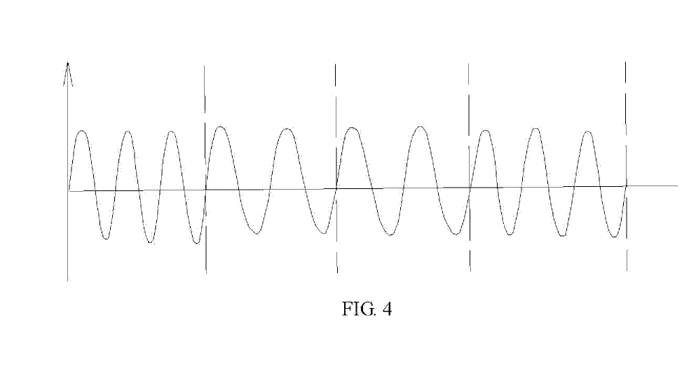

FIG. 3 is a schematic diagram of a power-taken circuit of a power-taken module. As shown in FIG. 3, the power-taken circuit comprises a plurality of phase-congruency modules 15 which are interconnected with each other. Each phase-congruency module comprises a first capacitor 151, a first diode 152. a second diode 153 and a second capacitor 154, wherein the first terminal of the first capacitor 151 constitutes a first input terminal of the phase-congruency module. The second terminal of the first capacitor 151 is connected with a positive electrode of the first diode 152. The positive electrode of the first diode 152 is connected with a negative electrode of the second diode 153. The two ends of the second capacitor 154 are connected with the positive electrode of the first diode 152 and the positive electrode of the second diode 153, respectively. Furthermore, the second terminal of the first capacitor 151 constitutes a first input terminal of the phase-congruency module. The negative electrode of the first capacitor 152 constitutes a second output terminal of the phase-congruency module. The negative electrode of the second capacitor 153 constitutes a second input terminal of the phase-congruency module. As to two adjacent phase-congruency modules, the first output terminal of the previous level of the phase-congruency module is electrically connected with the first input terminal of the next level of the phase-congruency module. The second output of the previous level of the phase-congruent module is electrically connected with the second input terminal of the phase-congruency module. The first soundtrack terminal 11 is electrically connected with the first input terminal of the first level of the phase-congruency module. The second input terminal of the first level of the phase-congruency module is grounded. The second output terminal of the final level of the phase-congruency module is a power source terminal. Preferably. a power-taken circuit has three or five phase-congruency modules. Preferably, the data receiving unit receives the signal from the mobile phone 100 through the second soundtrack terminal 12 and transforms the signal into data to be received based on the frequency of the signal. For example, as shown in FIG. 4, the signal of the first frequency (for example, 1.32 KHz) is facilitated to represent high level (that is, representing 1), but the signal of the second frequency is facilitated to represent low level (that is, representing 0). Therefore, the mobile phone can represent the binary data to be transmitted through the first frequency and the second frequency respectively, so as to realize the transmission of the data. Particularly, each group transmitted to the magnetic card reader by the mobile phone comprises two start bits, eight data bits, one check bit and one stop bit, so as to facilitate the data receiving unit to recognize the data. Particularly, sine wave which has four cycles and frequency of 2 KHz can be used to represent “1”, and the sine wave which has two cycles and frequency of 1 KHz is used to represent “0”.

Preferably, the data transmitting unit transforms the data to be transmitted into the signal with different frequencies and transmits the signal to the mobile phone 100 through the microphone terminal 13. For example, as shown in FIG. 4, the magnetic card reader uses the signal (for example, the sine wave) of the first frequency to transmit the “1” in binary data to be required to be transmitted, and uses the signal (for example, the sine wave) of the second frequency to transmit the “0” in the binary data. Therefore, the “1” and “0” in the binary data can be represented through the signals with different frequencies, so as to transmit the data to be required to be transmitted to the mobile phone through the microphone terminal. Particularly, sine wave which has four cycles and frequency of 2 KHz can be used to represent “1”, and the sine wave which has two cycles and frequency of 1 KHz is used to represent “0”.

Preferably, the key and the digital certificate are downloaded from the mobile phone 100 through the data receiving unit; that is, the key and the digital certificate are transmitted to the magnetic card reader by the mobile phone and stored in the encryption module, so as to update the key and digital certificate of the users.

Preferably, the encryption module adopts encryption algorithms such as DES, TDES, DUKPT MKSK (main key and working key. China UnionPay), FIXK (fixed key) and so on.

Preferably, the audio jack magnetic card is a magnetic stripe card. The magnetic stripe card comprises a bank card and a membership card. The bank card comprises a credit card.

The audio jack magnetic card reader takes power through the headphone jack of the mobile phone and implements two-way communication between the headphone jack of the mobile phone and the magnetic card reader, thus facilitating the magnetic card reader to have relatively good compatibility and be adapted to the mobile phone in different models. In addition, the invention is portable and thus can facilitate a mobile key to be a breakthrough in the application of financial transaction of the mobile phone thus enhancing the security of the financial transaction of the platform of the mobile phone.

What is claimed is:

1. An audio jack magnetic card reader, wherein comprising:
an audio interface connecting with a headphone jack of a mobile phone and comprising a first soundtrack terminal, a second soundtrack terminal, and a microphone terminal;
a data transmitting unit electrically connecting the microphone terminal so as to transmit the data to the mobile phone;
a data receiving unit electrically connecting the second soundtrack terminal so as to receive the data from the mobile phone;
an encryption module electrically connecting the data transmitting unit and the data receiving unit and stored with a key and a digital certificate;
a power-taken module of which the input terminal is electrically connected with the first soundtrack terminal and of which the output terminal provides power to the data transmitting unit, the data receiving unit and the encryption module;
a card slot for swiping a card; and
a control unit electrically connecting the data transmitting unit, the data receiving unit, the encryption module and the card slot.

2. The audio jack magnetic card reader of claim 1, wherein the power-taken module receives a sine audio signal from the mobile phone through the first soundtrack terminal.

3. The audio jack magnetic card reader of claim 2, wherein the power-taken module increases the voltage of the sine audio signal to be supply voltage through the way of phase congruency.

4. The audio jack magnetic card reader of claim 1, wherein the data receiving unit receives the signal from the mobile phone through the second soundtrack terminal and transforms the signal into a data to be received based on the frequency of the signal.

5. The audio jack magnetic card reader of claim 1, wherein the data transmitting unit transforms the data to be transmitted into the signal with different frequencies and transmits the signal to the mobile phone through the microphone terminal.

6. The audio jack magnetic card reader of claim 1, wherein the key and the digital certificate are downloaded and obtained from the mobile phone via the data receiving unit.

7. The audio jack magnetic card reader of claims 1, wherein the magnetic card is a magnetic stripe card.

8. The audio jack magnetic card reader of claim 7, wherein the magnetic stripe card comprises a bank card and a membership card.

9. The audio jack magnetic card reader of claim 7, wherein the bank card comprises a credit card.
